(19) United States
(12) Patent Application Publication
(10) Pub. No.: US 2010/0188368 A1
(43) Pub. Date: Jul. 29, 2010

(54) DISPLAY APPARATUS

(75) Inventors: Cristian Presura, Eindhoven (NL); Jan Frederik Suijver, Eindhoven (NL); Bernardus Hendrikus Wilhelmus Hendriks, Eindhoven (NL); Nenad Mihajlovic, Eindhoven (NL); Galileo June Destura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,059

(22) PCT Filed: Jun. 30, 2008
(86) PCT No.: PCT/IB08/52613

§ 371 Date: Dec. 29, 2009

(30) Foreign Application Priority Data
Jul. 2, 2007 (EP) 07111546.3

(51) Int. Cl. G06F 3/042

(52) U.S. Cl. 345/175

(57) ABSTRACT

Touch screen capabilities are added to a color display (10), such as an LCD display with backlighting. Thereto, the wavelength is varied in two color channels along the horizontal (x) and vertical (z) directions. A pen (30) having spectroscopic capabilities incorporated in it for the two relevant colors determines its position by measuring the wavelengths of the two channels.

### FIELD OF THE INVENTION

The present invention relates to an apparatus for displaying an image on a screen and more particularly to an apparatus providing touch screen functionality.

### BACKGROUND OF THE INVENTION

Large and small displays are more and more common in our life. Adding touch screen capabilities to them is desirable because of the added functionality that they offer. Typically, users prefer to interact in an intuitive way by touching of a screen with their own hands, over having to use external devices such as a keyboard or a mouse.

The following basic systems are currently used to recognize a person's touch: systems that sense pressure by making use of local changes in resistance or capacitance between two foils mounted on top of the screen and systems that make use of surface acoustic wave detection. For both of these the major problem lies in the added cost that they bring to the device, and as a result no large-scale market acceptance has occurred.

Most of the systems consist of a normal glass panel that is covered with a special layer. Accidental puncturing with a sharp instrument can easily damage this layer, and in addition the layer may block some of the light given by the display. Furthermore, the very real cost-issue, combined with the absence of a roadmap to realistically reduce these costs in the foreseeable future, implies that these displays will never become commercially interesting for low-income countries. This is especially a problem for an educational environment, where the benefit touch-screen displays bring to students and teachers alike can be huge.

The patent application US 2002/0067348 A1 discloses an alternative touch screen system to the basic systems described herein above. The system uses a plurality of infrared (“IR”) transmitters and receivers positioned along the edges of the screen, for determining with high resolution the location of a touch between the IR transmitters and receivers using on-axis and off-axis detection. The touch screen system uses, in conjunction with the on-axis and off-axis detection, a coarse and fine sweep of the transmitters and receivers to increase the resolution of identified touch location.

Also this system has the drawback of added costs caused by the considerable number of infrared transmitters and receivers that are needed.

It is an object of the invention to provide a low cost display apparatus with touch recognition functionality.

### SUMMARY OF THE INVENTION

This and other objects of the invention are achieved by an apparatus according to claim 1, a device according to claim 13, a system according to claim 18 and a method according to 19. Favorable embodiments are defined by the dependent claims 2-12 and 14-17.

According to an aspect of the invention a system is provided comprising an apparatus for displaying an image on a screen. The apparatus comprises light emitting means for emitting a light component that varies as a function of the position on the screen from which the light component is emitted. The system furthermore comprises a device for interacting with the apparatus. The device comprises means for detecting at least the light component emitted by the apparatus. Based on the detected light component a position or orientation of the device with respect to the screen of the apparatus may be determined.

According to the invention, touch functionality can be provided by providing some relatively simple modifications to the display apparatus and the device. Hereby significant additional costs are avoided. Furthermore, according to the invention the possibility of having a multiple entrance at one time is created, meaning that if two devices approach the screen at two different locations, it is possible to detect both locations.

The main application of the system according to the invention is providing touch screen functionality for TV or computer control. However, it may also be used for pointing devices and remote controls for larger displays. Here, light can be collected from a distance and from its spectrum the orientation of the pointing device can be determined.

Preferably, the detected light component is a light wavelength. However, also other light components may be used, such as a flickering frequency of light that is made to flicker at non-visible frequencies.

The determination of the position or orientation of the device with respect to the screen based on the detected wavelength of the light component may be performed by the device itself. Alternatively, the device transmits information on the detected wavelength of the light component to a further apparatus, which performs the determination of the position or orientation of the device with respect to the screen.

Preferably, the light component corresponds to a color channel of the display apparatus. Preferably, the total change in wavelength of the color channel is small, so that it is not noticeable with the bare eye. This variation of the wavelength will reduce the color rendering of the display, somewhat. However, when the color range is sufficiently small, this will not be a strong effect and the added functionality of the touch-screen capability will weigh stronger than the slightly reduced color rendering.

According to a first alternative the functionality of emitting the light component with a wavelength, that varies as a function of its position on the screen, is implemented by means of a plurality of light sources that emit the light component with mutually different wavelengths. This alternative is very suitable for use in a display apparatus wherein the color channel is implemented by light sources that all emit light of a certain basic color.

According to a second alternative this functionality is implemented by means of a plurality of light sources for emitting light with substantially the same wavelength and an optical filter with properties varying as a function of the screen position. The transmission spectrum of the optical filter is sharper than the transmission spectrum of the plurality of light sources. This alternative is very suitable for use in an LCD display apparatus with backlighting.

According to a further embodiment of the invention the light component varies as a function of the position on the screen along a first direction of the screen and the light emitting means are adapted for emitting a further light component with a wavelength that varies as a function of the position on the screen along a second direction of the screen, perpendicular to the first direction. By using two light components with non-overlapping wavelengths, the position of the device may be determined in two directions in a reliable way.

Preferably, the light components each correspond to a different color channel of the display apparatus.

Advantageously, the first color channel corresponds to the basic color blue and the second color channel corresponds to the basic color red. In case that the shortest wavelength of the basic color blue and the longest wavelengths of the basic color red are varied, a user will hardly notice any reduction of the color rendering of the display, because the parts of the emission spectrum that lie almost outside the human perception range are used to add the touch-screen functionality to the display apparatus.

The invention may be advantageously used in color displays wherein each pixel has in principle three basic colors whose intensities are changed during display. Examples thereof are LCD screens, CRT monitors and projection displays.

According to a further aspect of the invention a method is provided for determining a position or an orientation of a device with respect to the screen of an apparatus for displaying an image. The method comprises the steps of:

emitting a light component by the apparatus, that varies as a function of the position on the screen from which the light component is emitted,

detecting by the device of at least the light component emitted by the apparatus and

determining the position or orientation of the device with respect to the screen of the apparatus, based on at least the detected light component.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 schematically shows the technical principle of the display system according to the invention.

FIG. 2 shows a block diagram of the display system according to the invention.

FIG. 3 shows a side view of an embodiment of the display system according to the invention.

FIG. 4 shows a diagram further explaining the embodiment.

Throughout the figures like reference numerals refer to like elements.

### DETAILED DESCRIPTION OF EXAMPLES

Generally, each pixel of a color display has in principle three basic colors, red, green and blue, whose intensities are changed during display. In this way, a pixel can be made to appear any number of different colors. The number of colors that can be made by mixing red, green and blue depends on the number of distinct intensities that can be achieved by the display. This holds for a usual CRT monitor, for a LCD screen, a projection display, or other types of screens.

Usually, the wavelength of a specific color is the same for all the pixels of that color in the display. According to the invention, the wavelength from one pixel to another of two of the three basic colors is changed in a controlled way.

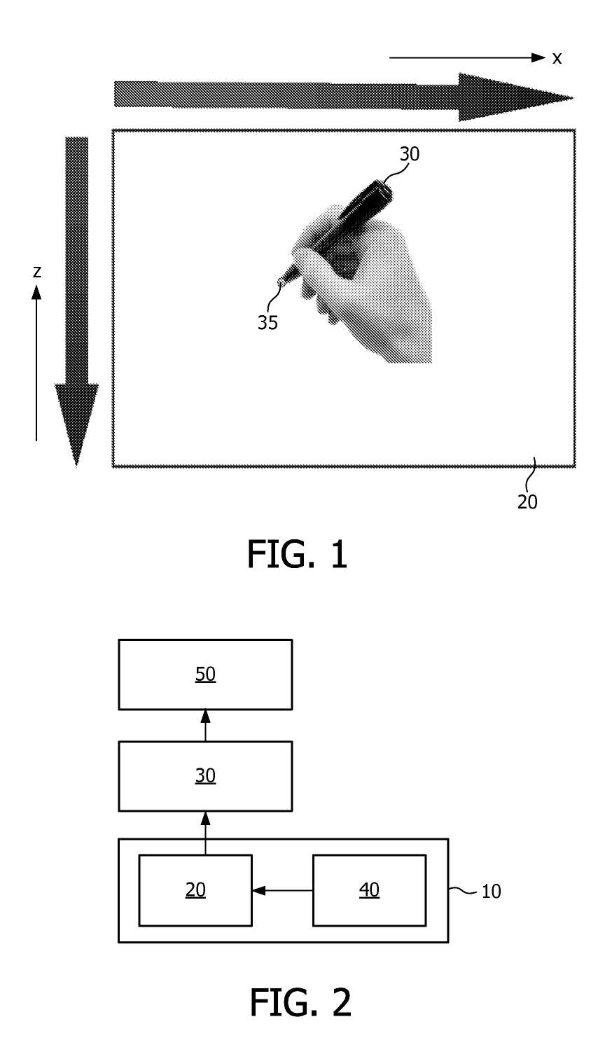

Referring now to FIG. 1 the principle of the system according to the invention is described. The figure shows the variation of two of the basic colors on a screen 20 of a display apparatus. A first basic color is varied along the vertical axis z. A second basic color is varied along the horizontal axis x. In the remainder, the invention will described for the case that the first basic color is red and the second basic color is blue. Of course this is only exemplary and any other mix of basic colors may be used. As shown in FIG. 1, each red pixel from top to bottom of the screen 20 goes from light red to dark red. Also, each blue pixel goes from light blue at the left part of the screen 20 to dark blue at the right part of the screen 20. The total change in wavelength must be small, such as not to be noticeable with the bare eye.

According to the invention, the position of a device 30 is read with respect to the screen 20. This device, which may be a pen, has a small integrated spectroscopic sensor 35. This sensor 35 registers the wavelengths of the red and blue color. The two red and blue peaks in the recorded spectrum will depend on the position of the pen. The pen can then read its position and send the result through a wireless connection to an interested device, such as a computer, TV, etc.

In addition to the position of the pen, it is also needed to measure if the pen has touched the screen 20 or not. This information can be easily obtained by incorporating a simple touch sensor (not shown) in the pen that generates an additional bit of information: the screen is touched or not. In case such a touch sensor is not suitable, the pen can also correlate the recorded intensity of the light detected from the screen 20 to the distance the pen is from the screen 20. In this way, a reasonable estimate of touching or not touching can be made.

FIG. 2 shows a block diagram of the system according to the invention. The display apparatus 10 comprises the screen 20, which was earlier referred to, which amongst others includes the functionality of varying the intensities of the three basic colors, red, green and blue of each pixel, during display. The display apparatus 10 further comprises light emitter functionality 40, which is adapted for varying the wavelength of the blue light along the horizontal axis of screen and the wavelength of the red light along the vertical axis. Furthermore, the system comprises a processor 50 for determining the position of the device 30 with respect to the screen based on the spectrum detected by the spectroscopic sensor 35. This processor may be part of the device 30 or of a further apparatus (which may be the display apparatus 10 itself), such as a computer or a TV. In the latter case, the device 30 wirelessly transmits information on the detected spectrum needed for the position determination to this apparatus.

The above principle can be used in a display apparatus 10 wherein the light emitting functionality 40 implements the color channels by means of light sources that all emit light of a certain basic color. By varying the wavelength of the light emitted by the red color LEDs in the vertical direction and the blue color LEDs in the horizontal direction, the light pattern as shown in FIG. 1 may be obtained. The wavelength of the red color LEDs in the horizontal direction and the blue color LEDs in the vertical direction is not varied. The wavelength of the green color LEDs is not varied at all.

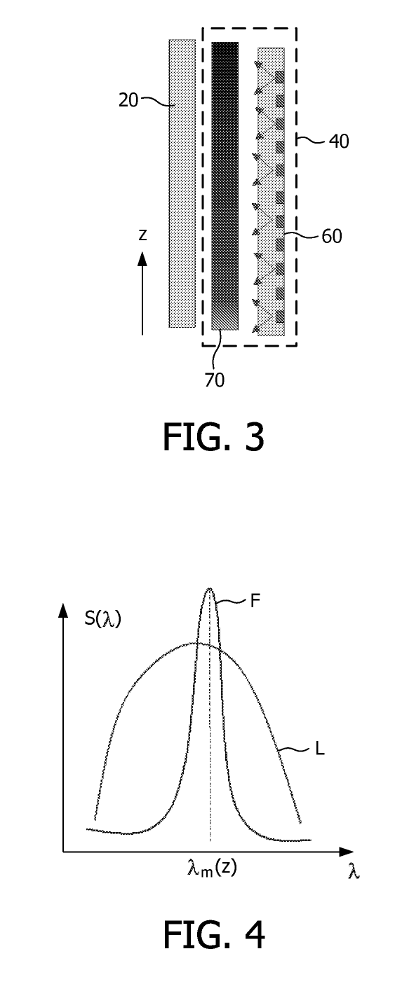

Alternatively, the above principle can be used in the case of the LCD displays with a LED backlight source 60, as shown in FIG. 3. Here, in principle, all LED's emit light at the same wavelength. Between the state of the art LCD panel 20 and the LED backlight source 60 an optical filter 70 is placed, whose filter properties depend on the position. So, the light emitting functionality 40 in this case is implemented by the LED backlight source 60 and the optical filter 70 together. So, the usual structure of the LCD display with backlight is used, the only addition thereto is the optical filter 70. FIG. 3 shows a side view of this structure, wherein the properties of the filter affecting the red color light component vary along the z-axis. The optical filter 70 has similar properties for the blue color light component along the horizontal axis x. This combination can provide the wavelength dependence needed for the display, as discussed earlier in this detailed description. FIG. 4 depicts the light strength S as function of the wavelength λ. The transmission spectrum L of each LED is quite broad. The transmission spectrum F of the filter 70 is sharper then the one of the LED's. It comprises two peaks, one for the blue color component and one for the red color component. Its maximum position λ_{b}, for the blue color component depends on the filter location, along the horizontal axis z. Its maximum position λr for the red color component depends on the filter location, along the vertical axis z. The optical filter used in this embodiment is continuous.

It is also possible to use a discontinuous filter, where the parts that comprise the filter properties are placed in front of the corresponding LEDs.

In order to minimize its influence on the user perception preferably the optical filter should mainly affect the shortest wavelengths of the blue pixels, as well as the longest wavelengths of the red pixels. In this way, the parts of the emission spectrum that lie almost outside the human perception range are used to add the touch-screen functionality to the display. It is even possible to use the wavelength in the infrared part of the red color channel, which is outside the human perception range.

The system may not only be used for providing touch screen functionality, but also with pointing devices and remote controls for larger displays. Here, light can be collected from a distance and from its spectrum the orientation of the pointing device can be determined. By varying the orientation of the pointing device, an apparatus may be controlled, such as a computer or a TV.

Furthermore, other light components than the wavelength may be varied based on the screen position such as the flickering frequency of the light, that is made to flicker at non-visible frequencies.

As will be recognized by those skilled in the art, the innovative concepts described in the present application can be modified and varied over a wide range of applications.

Accordingly, the scope of patented subject matter should not be limited to any of the specific exemplary teachings discussed, but is instead defined by the following claims.

Any reference signs in the claims shall not be construed as limiting the scope thereof.

1. Apparatus (10) for displaying an image on a screen (20) comprising light emitting means (40) for emitting a light component that varies as a function of the position on the screen (20) from which the light component is emitted.

2. Apparatus (10) according to claim 1 wherein the light component is a wavelength.

3. Apparatus (10) according to claim 2 wherein the light component corresponds to a color channel.

4. Apparatus (10) according to claim 2 wherein the light emitting means (40) comprise a plurality of light sources, for emitting the light component with mutually different wavelengths.

5. Apparatus (10) according to claim 2 wherein the light emitting means (40) comprise a plurality of light sources for emitting light with substantially the same wavelength and an optical filter (70) with properties varying as a function of the screen position, so that the wavelength of the light component varies as a function of the position on the screen from which the light component is transmitted.

6. Apparatus (10) according to claim 5 wherein a transmission spectrum of the optical filter (70) is sharper than a transmission spectrum of the plurality of light sources.

7. Apparatus (10) according to claim 5 wherein the light sources are backlights.

8. Apparatus (10) according to claim 2 wherein the light component varies as a function of the position on the screen (20) along a first direction (x) of the screen and wherein the light emitting means (40) are adapted for emitting a further light component with a wavelength that varies as a function of the position on the screen (20) along a second direction (z) of the screen, perpendicular to the first direction (x).

9. Apparatus (10) according to claim 8 wherein the light component corresponds to a first color channel and the further light component corresponds to a second color channel.

10. Apparatus (10) according to claim 9 wherein the light component comprises the shortest wavelengths of the basic color blue and the further light component comprises the longest wavelengths of the basic color red.

11. Apparatus (10) according to claim 1, wherein the light component is a flickering frequency.

12. Apparatus (10) according to claim 1, comprising means (50) for determining a position or orientation of a device (30) with respect to the screen (20), based on at least the detected light component at the device (30).

13. Device (30) for interacting with the apparatus (10) according to claim 1 comprising means (35) for detecting at least the light component emitted by the apparatus (10).

14. Device (30) according to claim 13 wherein the light component is a wavelength.

15. Device (30) according to claim 13 wherein the light component is a flickering frequency.

16. Device (30) according to claim 13 comprising means (50) for determining a position or orientation of the device (30) with respect to the screen (20) of the apparatus (10), based on at least the detected light component.

17. Device (30) according to claim 13 comprising touch sensing means for sensing a touch of the screen (20) by the device (30).

18. System comprising an apparatus (10) for displaying an image on a screen (20) comprising light emitting means (40) for emitting a light component that varies as a function of the position on the screen 20 from which the light component is emitted and a device (30) according to claim 14.

19. Method for determining a position or an orientation of a device (30) with respect to the screen (20) of an apparatus (10) for displaying an image comprising the steps of:
emitting a light component by the apparatus (10), that varies as a function of the position on the screen (20) from which the light component is emitted,
detecting by the device (30) of at least the light component emitted by the apparatus (10) and
determining the position or orientation of the device (30) with respect to the screen (20) of the apparatus, based on at least the detected light component.
